(19) United States
(12) Patent Application Publication
(10) Pub. No.: US 2012/0186097 A1
(43) Pub. Date: Jul. 26, 2012

(54) SUPERCRITICAL DRYING DEVICE AND METHOD

(76) Inventors: Hidekazu HAYASHI, Yokohama-Shi (JP); Hiroshi Tomita, Yokohama-Shi (JP); Hisashi Okuchi, Yokohama-Shi (JP); Yohei Sato, Yokohama-Shi (JP); Yukiko Kitajima, Komatsu-Shi (JP)

(21) Appl. No.: 13/160,350

(22) Filed: Jun. 14, 2011

(30) Foreign Application Priority Data
Jan. 21, 2011 (JP) 2011-10671

(51) Int. Cl. F26B 3/00; F26B 25/06

(52) U.S. Cl. 34/201; 34/443

(57) ABSTRACT

Certain embodiments provide a supercritical drying device, comprising a sealable first vessel; a fluorine adsorbent provided inside the first vessel; a second vessel being provided inside the first vessel and housing a semiconductor substrate; a heater heating the inside of the first vessel; a pipe connected to the first vessel; and a valve provided on the pipe. Free fluorine generated by heating a fluorine containing solvent is adsorbed to the fluorine adsorbent.

### CROSS REFERENCE TO RELATED APPLICATIONS

This application is based upon and claims benefit of priority from the Japanese Patent Application No. 2011-10671, filed on Jan. 21, 2011, the entire contents of which are incorporated herein by reference.

### FIELD

Embodiments described herein relate generally to a supercritical drying device and a supercritical drying method.

### BACKGROUND

A manufacturing process of a semiconductor substrate device includes a variety of processes such as a lithography process, an etching process and an ion planting process. After completion of each process and before shifting to the next process, a cleaning process and a drying process are implemented for removing impurities and a residue left on a wafer surface to clean the wafer surface.

For example, in wafer cleaning processing after the etching process, a chemical for cleaning processing is supplied to the wafer surface, and subsequently, pure water is supplied to perform rinsing processing. After the rinsing processing, the pure water remaining on the wafer surface is removed, to perform drying processing for drying the wafer.

As a method for performing the drying processing, there is known, for example, a method for substituting isopropyl alcohol (IPA) for the pure water on the wafer, to dry the wafer. However, there has been a problem that, at the time of this drying processing, a pattern formed on the wafer is collapsed due to surface tension of the liquid.

In order to solve such a problem, supercritical drying which makes surface tension zero has been proposed. For example, a wafer with its surface being wet with hydrofluoroether (HFE) is introduced into a chamber, and a pressure and a temperature inside the chamber are raised to bring HFE into a supercritical state. HFE in the supercritical state is then discharged to dry the wafer.

However, in the case of performing the supercritical drying by use of a fluorine containing solvent such as HFE, solvent molecules are pyrolyzed by heating to generate free fluorine. The free fluorine is bonded with moisture in the air to become hydrofluoric acid (HF), thereby having a problem of corroding the chamber or etching a semiconductor device material on the wafer, to cause deterioration in electrical characteristics of the semiconductor device.

### BRIEF DESCRIPTION OF THE DRAWINGS

FIG. 1 is a state diagram showing a relation of pressure, a temperature and a phase state of a substance;

FIG. 2 is a perspective view of a supercritical drying device according to an embodiment of the present invention;

FIG. 3A is a perspective view of an outer vessel of the supercritical drying device according to the embodiment;

FIG. 3B is a perspective view of an inner vessel of the supercritical drying device according to the embodiment;

FIG. 4 is a sectional view of the supercritical drying device according to the embodiment;

FIG. 5 is a flowchart explaining a supercritical drying method according to the embodiment;

FIG. 6 is a graph showing a vapor pressure curve of HFE; and

FIG. 7 is a sectional view of a supercritical drying device according to a modification.

### DETAILED DESCRIPTION

Certain embodiments provide a supercritical drying device, comprising a sealable first vessel; a fluorine adsorbent provided inside the first vessel; a second vessel being provided inside the first vessel and housing a semiconductor substrate; a heater heating the inside of the first vessel; a pipe connected to the first vessel; and a valve provided on the pipe. Free fluorine generated by heating a fluorine containing solvent is adsorbed to the fluorine adsorbent.

Hereinafter, an embodiment of the present invention is described based upon drawings.

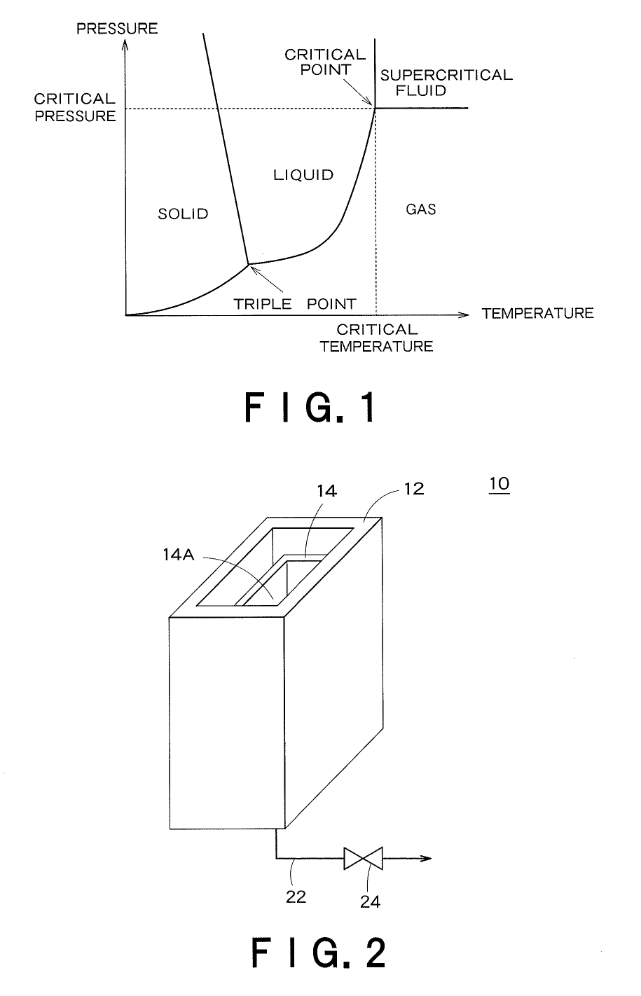

First, supercritical drying is described. FIG. 1 is a state diagram showing a relation of pressure, a temperature and a phase state of a substance. A functional substance of a supercritical fluid used in the supercritical drying has three states of existence, called three states, which are a gas phase (gas), a liquid phase (liquid) and a solid phase (solid).

As shown in FIG. 1, the three phases are separated by a vapor pressure curve (gas-phase equilibrium line) showing a boundary between the gas phase and the liquid phase, a sublimation curve showing a boundary between the gas phase and the solid phase, and a dissolution curve showing a boundary between the solid phase and the liquid phase. A place where these three phases overlap is a triple point. When the vapor pressure curve extends from this triple point to the higher temperature side, it reaches a critical point as a limitation of coexistence of the gas phase and the liquid phase. At this critical point, the gas phase and the liquid phase have equivalent densities, and the interface in a gas/liquid coexisting state disappears.

In a state where the temperature and the pressure are above the critical point, the difference between the gas phase and the liquid phase disappears, and the substance becomes a supercritical fluid. The supercritical fluid is a fluid compressed into a high density at a temperature not lower than a critical temperature. The supercritical fluid is similar to the gas at that spreading force of solvent molecules is dominant. Meanwhile, the supercritical fluid is similar to the liquid at that an influence of cohesive force of the molecules cannot be ignored, and hence has a characteristic of dissolving a variety of substances.

Further, the supercritical fluid has a very high infiltration property as compared with the liquid, and has a characteristic of being readily infiltrated into a fine structure. Moreover, the supercritical fluid is dried so as to change its state from the supercritical state directly to the gas phase, thereby making the interface between the gas and the liquid nonexistent, namely making capillary force (surface tension) not act, so that the supercritical fluid can be dried without collapsing the fine structure. The supercritical drying means drying of a substrate through use of the supercritical state of the supercritical fluid as thus described.

In the case of performing the supercritical drying by use of a fluorine containing solvent such as hydrofluoroether (HFE), solvent molecules are pyrolyzed by heating to generate free fluorine. For example, in AE-3000 (CF₃CH₂OCF₂CHF₂) manufactured by ASAHI GLASS CO., LTD, a C—H bond, a C—O bond and a C—F bond which have low bond dissociation energy are cut by thermal energy associated with heating, to generate free fluorine. Free fluorine has a problem of being bonded with moisture in the air to become hydrofluoric acid (HF), which decomposes the chamber or etches a semiconductor device material on the substrate to cause deterioration in electric characteristics of the semiconductor device. The present embodiment serves to solve such a problem.

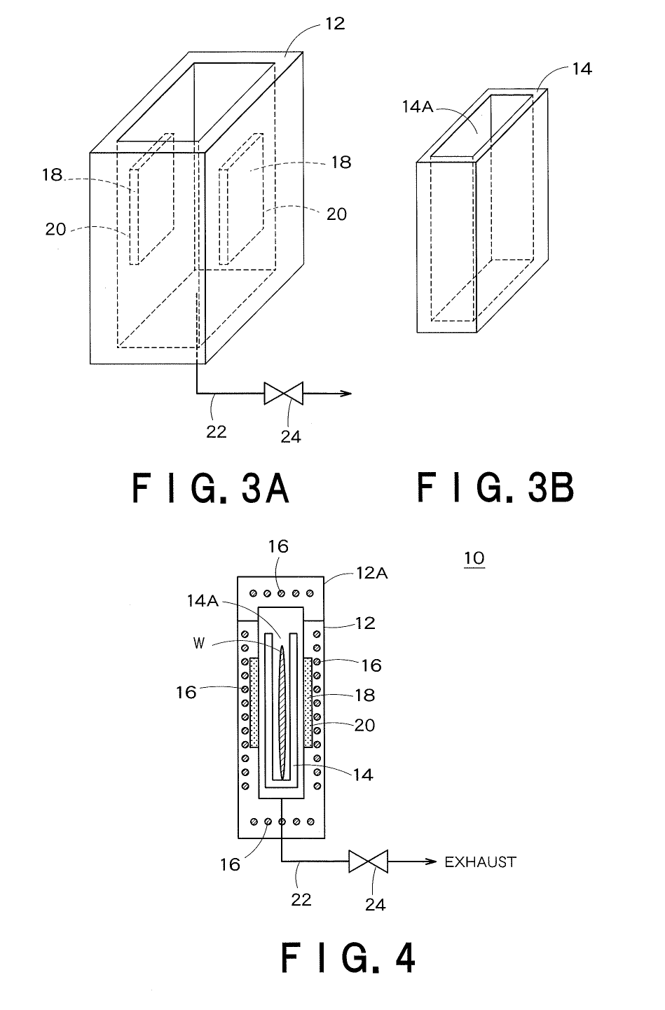

Next, a supercritical drying device 10 that performs supercritical drying of a semiconductor substrate is described using FIGS. 2 to 4. FIG. 2 is a perspective view of a supercritical drying device 10, FIGS. 3A and 3B are transparent perspective views separately showing an outer vessel 12 and an inner vessel 14 which are described later, and FIG. 4 is a sectional view of the supercritical drying device 10 in a state of being introduced with a semiconductor substrate W.

As shown in FIG. 2, the supercritical drying device 10 includes the outer vessel (first vessel) 12 as a pressure vessel for high pressure formed of SUS, nickel alloy or the like, and the inner vessel (second vessel) 14 that is provided inside the outer vessel 12 and houses the semiconductor substrate W. The inner vessel 14 may be formed of the same material as the outer vessel 12, but is preferably formed of quartz, a PEEK material or the like in consideration of metal contamination of the semiconductor.

As shown in FIG. 4, a heater 16 for adjusting a temperature inside the outer vessel 12 is built in the outer vessel 12. The outer vessel 12 is openable/closable, and with the outer vessel 12 in an open state, the semiconductor substrate W can be introduced into the outer vessel 12. Although FIGS. 2 and 3A show the open top outer vessel 12 for the sake of explanation, the top of the outer vessel 12 can be closed by a lid 12A in practice as shown in FIG. 4. Further, in FIG. 3A, illustration of the heater 16 is omitted.

It is to be noted that, although the configuration of the heater 16 being built in the outer vessel 12 is shown in FIG. 4, a configuration of the heater 16 being provided on the periphery of the outer vessel 12 may be formed.

As shown in FIGS. 3A and 4, a holding unit 20 for holding a fluorine adsorbent 18 is provided on an inner wall of the outer vessel 12. The holding unit 20 is, for example, a depression formed on the inner wall of the outer vessel 12, and the fluorine adsorbent 18 is fitted into this depression so that the fluorine adsorbent 18 is held inside the outer vessel 12. The fluorine adsorbent 18 can adsorb fluorine. Therefore, free fluorine generated inside the outer vessel 12 is adsorbed to the fluorine adsorbent 18. For this fluorine adsorbent 18, for example, activated alumina can be used. The fluorine adsorbent 18 can be removed from the holding unit 20 after use for a certain period, and exchanged with a new fluorine adsorbent 18.

As shown in FIGS. 2, 3B and 4, the inner vessel 14 is provided with an opening 14A for loading and unloading of the semiconductor substrate W.

The fluorine adsorbent 18 is held in the holding unit 20 provided on the inner wall of the outer vessel 12, and the semiconductor substrate W housed in the inner vessel 14 does not come into contact with the fluorine adsorbent 18. It is thereby possible to prevent fluorine adsorbed to the fluorine adsorbent 18 from being attached to the semiconductor substrate W.

As shown in FIGS. 2, 3A and 4, the pipe 22 is connected to the outer vessel 12, and the gas and the supercritical fluid inside the outer vessel 12 can be discharged to the outside through this pipe 22. The pipe 22 is provided with a control valve 24 that adjusts a valve opening degree, while monitoring and controlling inner pressure of the inside of the outer vessel 12. Closing the lid 12A of the outer vessel 12 and closing the control valve 24 can bring the inside of the outer vessel 12 into a sealed state.

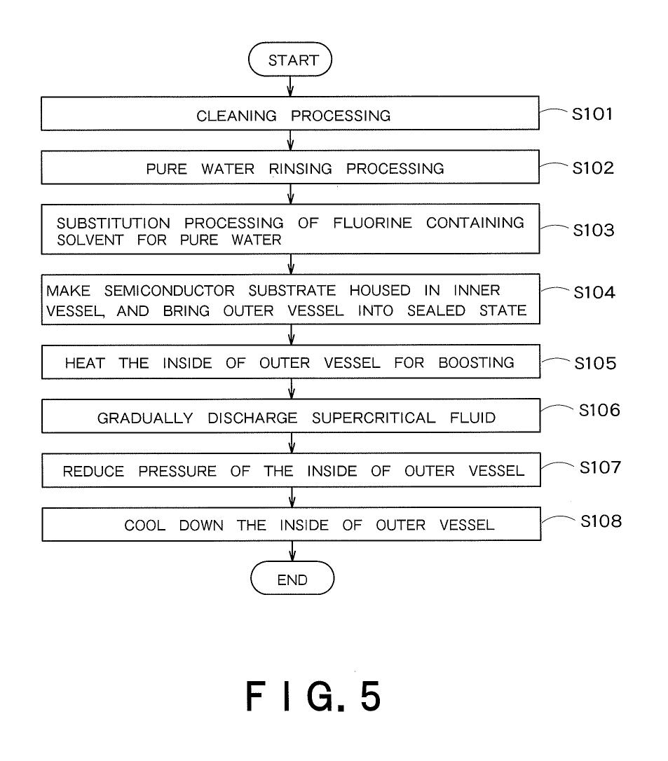

Next, cleaning and drying methods for the semiconductor substrate according to the present embodiment are described using a flowchart shown in FIG. 5.

(Step S101) The semiconductor substrate W as an object to be processed is carried into a cleaning chamber, not shown. A chemical is supplied to the surface of the semiconductor substrate W, and cleaning processing is performed. As the chemical, for example, sulfuric acid, fluorine, hydrochloric acid, hydrogen peroxide, or the like can be used.

Herein, the cleaning processing includes processing for peeling a resist off the semiconductor substrate W, processing for removing particles and metal impurities, processing for etching-removing a film formed on the semiconductor substrate W, and some other processing. A fine pattern is formed on the semiconductor substrate W. This fine pattern may be formed before the cleaning processing, or may be formed by this cleaning processing.

(Step S102) After the cleaning processing of Step S101, pure water is supplied to the surface of the semiconductor substrate W, and pure water rinsing processing is performed for rinsing the chemical left on the surface of the semiconductor substrate W by use of pure water.

(Step S103) After processing of the pure water rinsing processing of Step S102, liquid substitution processing is performed for immersing the semiconductor substrate W, with its surface wet with pure water, in a fluorine containing solvent to substitute the for the pure water as the liquid on the surface of the semiconductor substrate W. In the following description, hydrofluoroether (HFE) is used as the fluorine containing solvent.

(Step S104) After the liquid substitution processing of Step S103, the semiconductor substrate W is carried out of the cleaning chamber, with its surface kept in the state of being wet with HFE, so as not to naturally get dry. The outer vessel 12 shown in FIGS. 2 to 4 is then brought into an open state, and the semiconductor substrate W is housed into the inner vessel 14. In FIGS. 2 to 4, the semiconductor substrate W is housed into the inner vessel 14 in a vertical state. It is therefore preferable to previously fill the inner vessel 14 with HFE so that HFE does not disappear (run down) from the surface of the semiconductor substrate W. For example, a liquid supply unit that supplies HFE (fluorine containing solvent) to the supercritical drying device 10 is provided, and supplies HFE (fluorine containing solvent) to the inner vessel 14 at the time of making the semiconductor substrate W housed into the inner vessel 14.

After introduction of the inner vessel 14 housing the semiconductor substrate W into the outer vessel 12, the lid 12A of the outer vessel 12 is closed. The control valve 24 is then closed, to bring the inside of the outer vessel 12 into the sealed state.

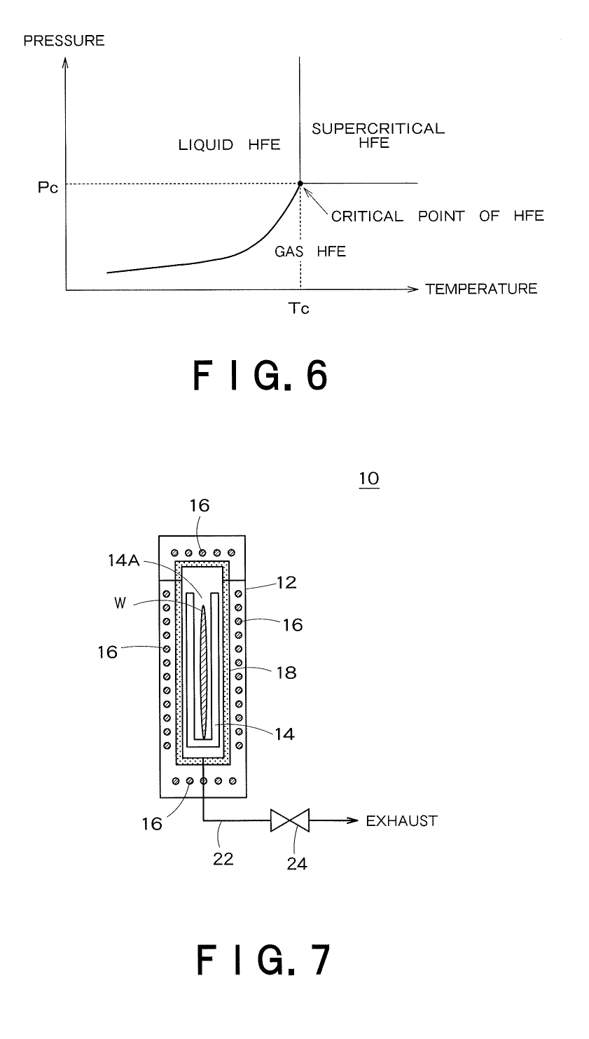

(Step S105) Inside the outer vessel 12 in the sealed state, HFE covering the surface of the semiconductor substrate W, namely HFE inside the inner vessel 14, is heated by use of the heater 16. The heated and vaporized HFE is diffused from the inner vessel 14 through the opening 14A, and fills the inside of the outer vessel 12. With increase in gas HFE, pressure inside the outer vessel 12 having been sealed to have a constant volume increases in accordance with a vapor pressure curve of HFE shown in FIG. 6.

Herein, actual pressure inside the outer vessel 12 is the sum total of partial pressure of all gas molecules existing inside the outer vessel 12, but in the present embodiment, a description is made with partial pressure of gas HFE regarded as the pressure inside the outer vessel 12.

As shown in FIG. 6, when HFE is heated to a temperature not lower than a critical temperature Tc in the state of the pressure inside the outer vessel 12 having reached critical pressure Pc of HFE, HFE (gas HFE and liquid HFE) inside the outer vessel 12 comes into a supercritical state. Thereby, the inside of the outer vessel 12 is filled with supercritical HFE (HFE in the supercritical state), and the surface of the semiconductor substrate W comes into the state of being covered with supercritical HFE.

It should be noted that, until HFE comes into the supercritical state, liquid HFE covering the surface of the semiconductor substrate is prevented from being all vaporized, that is, liquid HFE is made to keep the semiconductor substrate W wet and to remain inside the inner vessel 14.

By substituting the temperature Tc, the pressure Pc and the capacity of the outer vessel 12 into a gas-state equation (PV=nRT; P is pressure, V is volume, n is number of moles, R is gas constant, T is temperature), an amount nc (mol) of HFE existing in a gas state inside the outer vessel 12 can be obtained at the time of HFE coming into the supercritical state. Therefore, before the start of heating in Step S105, liquid HFE in amount not smaller than nc (mol) needs to exist inside the inner vessel 14.

By heating of HFE in the present step, the solvent molecules are pyrolyzed to generate free fluorine, and this free fluorine is adsorbed to the fluorine adsorbent 18. This can prevent free fluorine from bonding with moisture in the air. It is thereby possible to suppress generation of hydrofluoric acid (HF) due to the bonding between free fluorine and moisture, so as to prevent the outer vessel 12 and the inner vessel 14 from corroding and the semiconductor device on the semiconductor substrate W from being etched.

(Step S106) After HFE has come into the supercritical state in Step S105, the control valve 24 is opened, to gradually discharge supercritical HFE inside the outer vessel 12 through the pipe 22.

(Step S107) After supercritical HFE inside the outer vessel 12 has been discharged for predetermined time, an opening degree of the control valve 24 is made larger, to reduce the pressure inside the outer vessel 12.

(Step S108) After the pressure inside the outer vessel 12 has been reduced to atmospheric pressure, the outer vessel 12 is cooled down and the lid 12A is opened. The semiconductor substrate W is taken out from the inner vessel 14, and carried out of the outer vessel 12.

As thus described, in the present embodiment, HFE covering the surface of the semiconductor substrate W is changed from the liquid into the supercritical state, and supercritical HFE is discharged from the outer vessel 12, to dry the semiconductor substrate W. Therefore, capillary force (surface tension) does not act on the fine pattern on the semiconductor substrate, and the semiconductor substrate W can be dried without destroying the fine pattern.

Further, adsorbing free fluorine generated at the time of heating HFE to the fluorine adsorbent 18 can suppress generation of hydrofluoric acid (HF) due to the bonding between free fluorine and moisture. This can prevent the outer vessel 12 from corroding. Further, it is possible to prevent the semiconductor device material on the semiconductor substrate W from being etched, so as to prevent the electrical characteristics of the semiconductor device from deteriorating.

The semiconductor substrate W is housed in the inner vessel 14 in the vertical state in the present embodiment as shown in FIGS. 2 to 4, but it may be housed in a horizontal state. Further, the supercritical drying device 10 may have a chamber configuration capable of housing a plurality of semiconductor substrates. Moreover, before housing of the semiconductor substrate into the inner vessel 14, or after introduction of the inner vessel 14 housing the semiconductor substrate W into the outer vessel 12, it is preferable to remove a redundant solvent that does not contribute to pattern destruction.

Further, although the fluorine adsorbent 18 has been fitted to the holding unit 20 provided on the inner wall of the outer vessel 12 in the above embodiment, the inner wall of the outer vessel 12 may be coated by the fluorine adsorbent 18, as shown in FIG. 7. Moreover, the fluorine adsorbent 18 may be fitted to an outer wall of the inner vessel 14, or the outer wall of the inner vessel 14 may be coated by the fluorine adsorbent 18. In the case of coating by the fluorine adsorbent 18, by supplying nitrogen or carbon dioxide to the inside of the outer vessel 12 and heating, fluorine adsorbent 18 can be regenerated. The fluorine adsorbent 18 may be neither fitted nor coated, but may just be placed as it is inside the outer vessel 12 (so as not to come into contact with the semiconductor substrate W).

For the fluorine adsorbent 18, a mixture of a polymer resin and hydroxide containing a rare earth element can be used as well as activated alumina. Herein, hydroxide containing a rare earth element is a rare earth element in group 3(3A) in accordance with the periodic table of the elements, which is hydroxide containing scandium, yttrium, a lanthanoid element, lanthanum, cerium, praseodymium, neodymium, promethium, samarium, europium, gadolinium, terbium, dysprosium, holmium, erbium, thulium, ytterbium or lutetium. A mixture of these hydroxide containing rare earth elements may be used. Further, examples of the polymer resin include a fluorine resin, a vinylidene fluoride resin, a vinyl chloride resin, a vinylidene chloride resin, polystyrene, a vinyl alcohol copolymer resin, polysulfone, polyacrylonitrile, and a copolymer of these.

In the above embodiment, the supercritical drying has been described in which a fluorine containing solvent such as HFE is heated to a temperature not lower than the critical temperature, to boost pressure inside the outer vessel 12 to pressure not lower than the critical pressure of the fluorine containing solvent, but even when drying is performed on conditions of the pressure inside the outer vessel 12 and the temperature of the fluorine containing solvent being lower than the critical point, the supercritical drying device according to the present embodiment is preferably used in the case of free fluorine being generated by heating.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A supercritical drying device, comprising:
a sealable first vessel;
a fluorine adsorbent provided inside the first vessel;
a second vessel being provided inside the first vessel and housing a semiconductor substrate;
a heater heating the inside of the first vessel;
a pipe connected to the first vessel; and
a valve provided on the pipe.

2. The supercritical drying device according to claim 1, wherein the fluorine adsorbent is provided on an inner wall of the first vessel.

3. The supercritical drying device according to claim 1, wherein the fluorine adsorbent is provided on an outer wall of the second vessel.

4. The supercritical drying device according to claim 1, wherein the fluorine adsorbent is activated alumina or a mixture of a polymer resin and hydroxide containing a rare earth element.

5. The supercritical drying device according to claim 1, further comprising
a supply unit that supplying a fluorine containing solvent to the second vessel.

6. The supercritical drying device according to claim 1, wherein the second vessel is formed of quartz or a PEEK material.

7. The supercritical drying device according to claim 1, wherein the fluorine adsorbent is removable from the inside of the first vessel.

8. The supercritical drying device according to claim 2, wherein the fluorine adsorbent is made to coat the inner wall of the first vessel.

9. The supercritical drying device according to claim 3, wherein the fluorine adsorbent is made to coat the outer wall of the second vessel.

10. A supercritical drying method by use of a supercritical drying device including a first vessel, a fluorine adsorbent provided inside the first vessel, an inner vessel provided inside the first vessel, a heater heating the inside of the first vessel, a pipe connected to the first vessel, and a valve provided on the pipe, comprising:
housing a semiconductor substrate into the second vessel in the state of a surface of the substrate being wet with a fluorine containing solvent;
closing the valve to seal the inside of the first vessel after housing of the semiconductor substrate,
heating the fluorine containing solvent by use of the heater to change the fluorine containing solvent into a supercritical fluid after sealing of the inside of the semiconductor substrate;
opening the valve to discharge the supercritical fluid from the first vessel through the pipe for predetermined time; and
reducing pressure inside the first vessel to atmospheric pressure after discharging of the supercritical fluid.

11. The supercritical drying device according to claim 10, wherein
the semiconductor substrate is cleaned by use of a chemical,
the semiconductor substrate is rinsed by use of pure water after cleaning of the semiconductor substrate, and
the fluorine containing solvent is substituted for the pure water on the semiconductor substrate after rinsing of the semiconductor substrate by use of the pure water and before housing of the semiconductor substrate into the second vessel.
